(19) United States
(12) Patent Application Publication
(10) Pub. No.: US 2007/0006536 A1
(43) Pub. Date: Jan. 11, 2007

(54) VEHICLE DOOR WITH BLIND LOAD TRIM/HARDWARE MODULE

(75) Inventors: John David Youngs, Southgate, MI (US); Bogdan Radu, Dearborn, MI (US)

Correspondence Address: BIR LAW, PLC, 13092 GLASGOW CT., PLYMOUTH, MI, 48170-5241, US

(73) Assignee: LEAR CORPORATION, Southfield, MI (US)

(21) Appl. No.: 10/905,622

(22) Filed: Jan. 13, 2005

(51) Int. Cl. B60J 5/04

(52) U.S. Cl. 49/502

(57) ABSTRACT

A blind load vehicle door module includes a first exposed side having interior trim and a second hidden side with at least a door latch actuator and window regulator mechanism, wherein the module has a plurality of connectors extending from the hidden side including at least two lower connectors insertable into corresponding slots of a door frame to allow pivoting during assembly of the module about the lower connectors to insert at least one upper connector into a corresponding slot of the door frame, the plurality of connectors being slidable within the corresponding slots of the door frame from an inserted position to a locking position to secure the module to the door frame. One or more threaded fasteners may be used to secure the module in the locking position.

### FIELD OF THE INVENTION

The present invention relates to a vehicle door assembly and process.

### BACKGROUND ART

Assembly of vehicle doors typically includes securing various hardware components and subassemblies, such as window/mirror/seat controls, door latches and locks, window regulator and glass, speakers, etc., to a door frame or similar structure. Access holes or openings are provided in the door frame to accommodate the hardware and provide access to fasteners used to secure the hardware to the sheet metal (or other structural material) of the door frame. A trim panel is used to cover the access holes/openings and position various accessory controls for convenient operation while providing an aesthetically pleasing appearance for the interior of the vehicle. Vehicle door modules or subassemblies having various hardware components secured to an intermediate carrier or directly to the back side of an interior trim panel have been developed to improve the assembly process and reduce costs. Even these door modules typically include one or more access panels (bolsters) to allow attachment of window regulator arms or other hardware to the door frame.

### SUMMARY OF THE INVENTION

The present invention includes a blind load vehicle door module having a first exposed side including interior trim and a second hidden side with at least a door latch actuator and window regulator mechanism, wherein the module has a plurality of connectors extending from the hidden side including at least two lower connectors insertable into corresponding slots of a door frame to allow pivoting during assembly of the module about the lower connectors to insert at least one upper connector into a corresponding slot of the door frame, the plurality of connectors being slidable within the corresponding slots of the door frame from an inserted position to a locking position to secure the module to the door frame. One or more mechanical fasteners may be used to secure the module in the locking position.

Various embodiments of the present invention include a blind load vehicle door module having a first side exposed after assembly including an arm rest, accessory controls, and a speaker grille, and a second side concealed or hidden from view after assembly having a plurality of components secured thereto including at least a door latch mechanism, a device for raising and lowering a window, and a plurality of connectors that facilitate placement of the module on a vehicle door frame in a pivoting position to allow connection of the wiring harness and/or other hardware, sliding of the module to a final assembly position, and securing of the module in the final assembly position. Various embodiments may also include a wiring harness routing device, a speaker, and other hardware secured to the back or hidden side of the module. Different connectors may be used to provide the pivoting and sliding of the module during assembly. For example, upper connectors may have a “T”-shaped cross-section with a round head while lower connectors may have a “J”-shaped cross-section to secure the lower portion of the module to the door frame and allow assembly/connection of interior door hardware prior to pivoting and sliding the module to its final assembly position. Corresponding slots in the vehicle door frame may include a ramped projection or similar feature to pull or draw the module and frame together as the module slides from the insertion position to the locking or final assembly position. These projections or features may be integrally formed in the slots or may be added using spring clip inserts, for example.

The present invention provides a number of advantages. For example, the present invention provides a vehicle door module that does not require a separate access panel or bolster to secure the window regulator mechanism to the door frame. The invention provides a slot and key attachment strategy that includes an initial position that allows for assembly and/or connection of a wiring harness or other hardware, and pivoting and sliding to a final position that secures the module to the door frame without an access panel or holes. Use of a one-piece door trim panel for door modules according to the present invention may reduce or eliminate the cost associated with a separate access panel or bolster to secure the window regulator arms.

The above advantages and other advantages and features of the present invention will be readily apparent from the following detailed description of the preferred embodiments when taken in connection with the accompanying drawings.

### BRIEF DESCRIPTION OF THE DRAWINGS

FIG. 1 is a perspective view of illustrating a method for assembly and a partially assembled vehicle door having a blind load module according to one embodiment of the present invention;

FIG. 2 illustrates the hidden or concealed side of a blind load door module along with the process of securing various hardware components to the module according to one embodiment of the present invention;

FIG. 3 is a perspective view of an alternative embodiment of a vehicle door frame illustrating one alternative for securing a door module in a final assembly position according to one embodiment of the present invention;

FIG. 4 is a perspective view of the exposed side of a vehicle door with a blind load module after assembly according to one embodiment of the present invention; and

FIG. 5 is a perspective view of a representative slot for a vehicle door frame having an integrally formed ramp or wedge feature to draw the door module toward the door frame as the door module pivots and slides from an initial assembly position to a final assembly position according to one embodiment of the present invention.

### DETAILED DESCRIPTION OF THE PREFERRED EMBODIMENT(S)

As those of ordinary skill in the art will understand, various features of the present invention as illustrated and described with reference to any one of the Figures may be combined with features illustrated in one or more other Figures to produce embodiments of the present invention that are not explicitly illustrated or described. The combinations of features illustrated provide representative embodiments for typical applications. However, various combinations and modifications of the features consistent with the teachings of the present invention may be desired for particular applications or implementations.

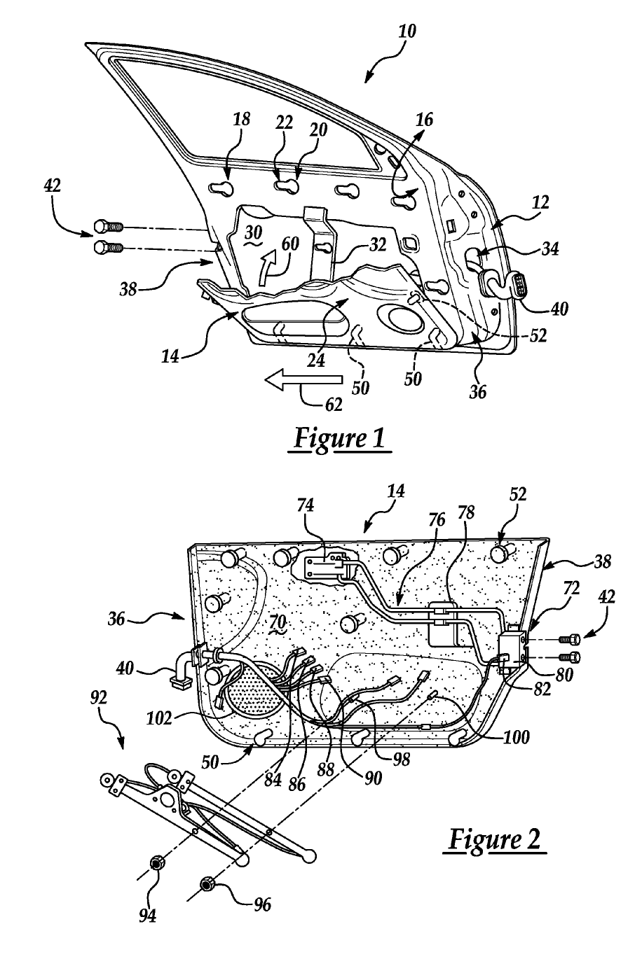

Referring now to FIG. 1, a perspective view illustrating a method for assembly and a partially assembled vehicle door having a blind load module according to one embodiment of the present invention is shown. Vehicle door 10 includes a structural door frame 12 and a blind load vehicle door module 14 preferably having a unitary, one-piece construction without an access panel or bolster. Module 14 is secured to an interior surface 16 of door frame 12 using a plurality of elongated slots 18. In this embodiment, each elongated slot 18 has a generally rounded insertion portion 20 connected to a generally oval portion 22 defining corresponding positions for door module 14 during assembly as described in greater detail below. Blind load vehicle door module 14 includes an interior trim side or surface 24 that will be exposed visible by an occupant of the vehicle after final assembly. As such, door module 14 preferably covers any access holes 30 in addition to elongated slots 18 and any other openings that would otherwise be visible to a vehicle occupant to provide an aesthetically pleasing appearance while securing various door hardware to door frame 12.

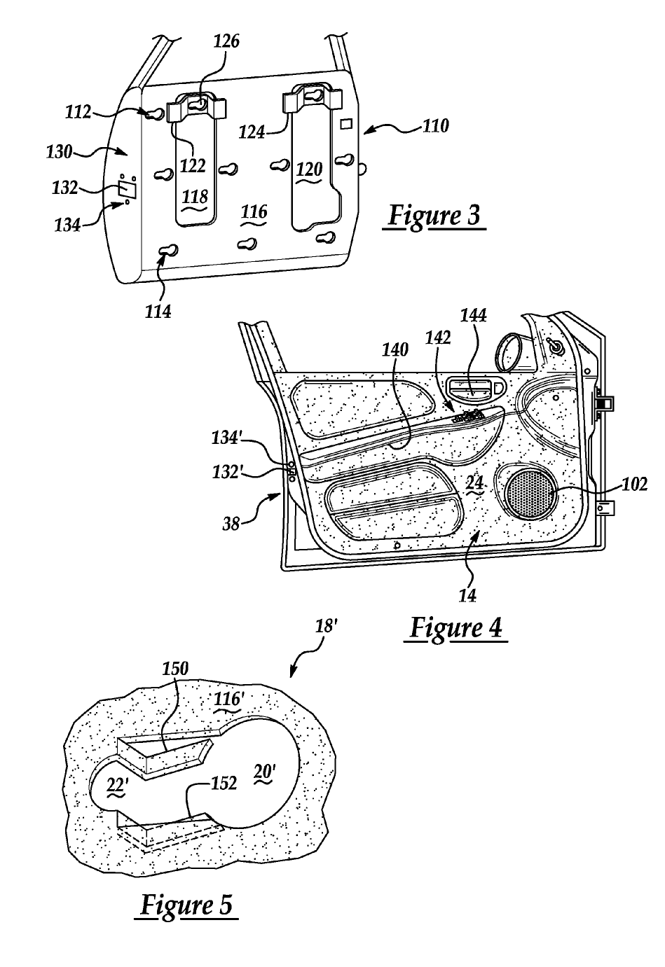

Depending upon the particular application and implementation, access hole 30 may include one or more support structures or rails 32 having one or more elongated slots to engage corresponding connectors 50, 52 on door module 14 (best illustrated in FIG. 2). As shown in FIG. 1, rail 32 extends vertically across access opening 30 and is recessed relative to interior surface 16 to provide suitable clearance for various door hardware, such as a window regulator or door latch mechanism, for example. For other applications, one or more rails 32 may be provided and oriented horizontally as illustrated in FIG. 3 rather than vertically oriented as shown in FIG. 1. Similarly, access opening 30 may be divided by an integral structural support as in the embodiment illustrated in FIG. 3, for example.

As also illustrated in FIG. 1, door frame 12 may include one or more openings 34 in a front or forward surface 36 to accommodate a wiring harness 40. Similarly, door frame 12 may include one or more openings in back or rear surface 38 to accommodate a door latching mechanism, for example. In the embodiment illustrated, lower connectors 50 are inserted into corresponding elongated slots in door frame 12 so that module 14 is supported in a partially open position as illustrated to provide access to opening 30 during assembly or connection of various door hardware components secured to the concealed side of module 14, which may include one or more controls for accessories such as a vehicle mirror, power seats, power windows, power locks, etc. In addition, the partially open position illustrated in FIG. 1 provides access to a window regulator or other device used for raising and lowering a window. After connecting or assembling any components secured to the back side of module 14, the module is pivoted about lower connectors 52 as represented by arrow 62 to insert upper connectors 52 (best shown in FIG. 2) into corresponding elongated slots 18 of door frame 12. When the upper connectors have engaged the rounded portion 20 of elongated slots 18, module 14 is said to be in the initial or insertion position. Assembly of door 10 continues by sliding door module 14 from the insertion position to a final assembly position as represented by arrow 62 so that the connectors move toward the final assembly position represented by portion 22 of elongated slots 18 and the upper connectors engage the corresponding elongated slots 18 of door frame 12 to secure door module 14 to door frame 12. Module 14 may be secured in the final assembly position using one or more threaded fasteners 42. In the embodiment illustrated in FIG. 1, threaded fasteners 42 engage a latching mechanism that is also secured to module 14 so that module 14 is secured in the final assembly or locking position.

FIG. 2 illustrates the hidden or concealed side of a blind load door module along with the process of securing various hardware components to the module according to one embodiment of the present invention. As shown in FIG. 2, the hidden or concealed side 70 of module 14 includes a plurality of connectors 50, 52 extending from concealed side 70. Preferably, connectors 50, 52 are integrally formed from the base or substrate of module 14. The plurality of connectors includes at least two lower connectors 50 insertable into corresponding elongated slots 18 of door frame 12 to allow pivoting of module 14 about lower connectors 50 during assembly to provide access to various door hardware such as latching mechanism 72, wiring harness 40, window regulator 92, etc. After any necessary hardware is assembled and/or connected, lower connectors 50 allow panel 14 to be pivoted so that upper connectors 52 engage corresponding elongated slots 18 in door frame 12 in an insertion position as described above. As module 14 slides toward the final assembly position, connectors 50, 52 secure module 14 to door frame 12. Latching mechanism 72, which is secured to hidden side 70 of module 14, may include one or more threaded holes which align with corresponding holes in the back side 38 of door frame 12 so that module 14 may be secured in the final assembly position by threaded fasteners 42.

Depending upon the particular application, lower connectors 50 may have a different cross-section than upper connectors 52. As illustrated in FIG. 2, lower connectors 50 may be implemented by “J”-shaped or hook-shaped connectors to facilitate support of module 14 from door frame 12 and pivoting of module 14 as described above. Upper connectors 52 may be implemented by circular or rectangular “T”-shaped connectors that secure module 14 to door frame 12 after sliding into oval portion 22 of elongated slots 18. In one embodiment, upper connectors 52 are implemented by an integrally formed shaft extending from surface 70 of module 14 and terminating in a disk to provide a “T”-shaped cross-section. Of course, connectors 50, 52 may be implemented by various types or shapes of connectors to provide the indicated pivoting and sliding functionality of the present invention. Similarly, lower connectors 50 and upper connectors 52 may have substantially similar shapes and/or sizes depending upon the particular application.

Preferably, module 14 is provided as a subassembly to the final door assembly process. During subassembly, various door hardware is secured to concealed side 70 of module 14. Hardware may include a latching mechanism 72 which has a door handle or lever component 74 connected by linkage 76 to an actuator module 80. In the embodiment illustrated, actuator module 80 may be electrically controlled by connecting an appropriate plug 82 from wiring harness 40. Wiring harness 40 may also include additional plugs or connectors 84, 86, 88, and 90 that may be connected to corresponding vehicle accessory control terminals to connect common vehicle accessories and/or controls such as speakers, windows, and seat adjusters, for example, to wiring harness 40. A conventional window regulator 92 or a similar device for raising and lowering a window (not shown) may be secured by appropriate fasteners 94, 96 which engage corresponding threaded studs 98, 100 or similar features of module 14.

FIG. 3 is a perspective view of an alternative embodiment of a vehicle door frame 110 illustrating one alternative for securing a door module in a final assembly position according to one embodiment of the present invention. Door frame 110 includes a plurality of upper horizontally elongated slots 112 and lower horizontally elongated slots 114. Integral structural support 116 separates hardware access holes 118, 120 and may also include one or more elongated slots as illustrated. Of course, those of ordinary skill in the art will recognize that the pivot, slide, and lock assembly features of a blind load door module according to the present invention may be implemented using elongated slots in any of a variety of generally parallel orientations that allow the module to move from an insertion or initial position to a final assembly position and be secured in the final assembly position as described and illustrated. Similarly, one or more supplemental rails or other structural supports as represented by supports 122, 124 may span a portion of one or more access openings 118, 120 to provide sufficient structural support for corresponding door hardware secured to a modular door trim/hardware panel while being capable of blind loading, i.e. not requiring separate access panels or bolsters to secure door hardware to the door frame. Supports 122, 124 may be recessed to provide appropriate clearance for various door hardware, with one or more elongated slots provided to secure the door module to the door frame. As also shown in FIG. 3, door frame 110 may include a rear surface 130 having an access hole or opening 132 for a latching mechanism and corresponding fastener holes 134 to secure the blind load module in a final assembly position.

FIG. 4 is a perspective view of the exposed side of a vehicle door with a blind load module after assembly according to one embodiment of the present invention. As such, door module 14 has been assembled by pivoting about lower connectors (not shown) and sliding toward rear surface 38 with latching mechanism 132′ secured via holes 134′ in the door frame with appropriate fasteners. Exposed or visible side 24 of module 14 is preferably formed from a one-piece unitary construction that provides a speaker grille 102 an arm rest 140, convenient access to vehicle accessory controls 142, and a door handle or lever 144.

FIG. 5 is a perspective view of a representative slot for a vehicle door frame having a device for pulling the blind load door module and door frame together as the door module slides into the final assembly position. In the representative embodiment illustrated, elongated slot 18′ includes a rounded portion 20′ defining an insertion position connected to an oval portion, the distal end of which defines a final assembly position. Elongated slot 18′ includes an integrally formed ramp or wedge feature 150, 152 to draw the door module and door frame together as the door module slides from an initial assembly position to a final assembly position. The ramp or wedge feature may be formed on only one side of oval portion 22′ rather than both sides as shown in FIG. 5. Various alternative implementations of an integrally formed device or feature may also be provided, such as a ramped projection or dimple in surface 116′. A ramp or wedge feature may also be provided by an insert placed in elongated slot 18′ if desired. A similar ramp or wedge feature may also be incorporated into one or more of the connectors of the door module. Preferably, at least two upper slots and/or connectors and at least two lower slots and/or connectors incorporate such a feature to reduce or eliminate any play between the door frame and door module after installation.

As illustrated and described with reference to FIGS. 1-5, the present invention provides a blind load vehicle door module that does not require a separate access panel or bolster to secure the window regulator mechanism to the door frame. The invention provides a slot and key attachment strategy that includes an initial position that allows for assembly and/or connection of a wiring harness or other hardware, and pivoting and sliding to a final position that secures the module to the door frame without an access panel or access holes. Use of a one-piece door trim panel for door modules according to the present invention may reduce or eliminate the cost associated with a separate access panel or bolster to secure the window regulator arms.

While the best mode for carrying out the invention has been described in detail, those familiar with the art to which this invention relates will recognize various alternative designs and embodiments for practicing the invention as defined by the following claims.

What is claimed is:

1. A vehicle door comprising:
a door frame including a plurality of elongated slots;
a blind load door module having a first side exposed after final assembly including interior trim and a second side concealed after final assembly;
a door latch actuator secured to the concealed side of the blind load door module; and
a device for raising and lowering a window secured to the concealed side of the blind load door module;
wherein the blind load door module has a plurality of connectors extending from the concealed side including at least two lower connectors insertable into corresponding elongated slots of the door frame to allow pivoting during assembly of the module about the lower connectors to insert at least one upper connector into a corresponding elongated slot of the door frame, the plurality of connectors being slidable within the corresponding elongated slots of the door frame from an inserted position to a locking position to secure the module to the door frame.

2. The vehicle door of claim 1 wherein the door latch actuator is further secured to the door frame to secure the blind load vehicle door module in the locking position.

3. The vehicle door of claim 2 wherein the door latch actuator is secured to the door frame by a plurality of threaded fasteners exposed after final assembly.

4. The vehicle door of claim 1 wherein the plurality of elongated slots comprises a plurality of horizontally elongated slots.

5. The vehicle door of claim 1 wherein the plurality of connectors comprises connectors having a “T”-shaped cross-section.

6. The vehicle door of claim 1 wherein the at least two lower connectors have a “J”-shaped cross-section and the at least one upper connector has a “T”-shaped cross-section.

7. The vehicle door of claim 1 further comprising a device for routing a wiring harness secured to the concealed side of the blind load door module.

8. The vehicle door of claim 1 wherein at least two of the plurality of elongated slots include a device for pulling the blind load door module and the door frame together as the blind load door module slides from the inserted position to the final assembly position.

9. The vehicle door of claim 8 wherein the device for pulling the blind load door module and the door frame together comprises a ramped projection extending away from an interior surface of the door frame.

10. The vehicle door of claim 9 wherein the ramped projection is integrally formed in the interior surface of the door frame.

11. A blind load vehicle door module for use with a vehicle door frame having a plurality of elongated slots, the module comprising:
a first side exposed after final assembly including an arm rest and controls for at least one vehicle accessory;
a second side concealed from view after final assembly having a plurality of components secured thereto including at least a door latch mechanism, a wiring harness routing device, and a device for raising and lowering a window, the second side including a plurality of integrally formed connectors extending therefrom, the connectors including a plurality of lower connectors to facilitate placement of the module on a vehicle door frame in a pivoting position to allow connection of a wiring harness to the controls for the at least one vehicle accessory and a plurality of upper connectors to facilitate sliding of the module within the elongated slots to a final assembly position where at least the upper connectors prevent the module from pivoting.

12. The module of claim 11 wherein the lower connectors are hook-shaped.

13. The module of claim 11 wherein the upper connectors comprise a shaft extending from the second side terminating in an integrally formed disk.

14. The module of claim 11 wherein the upper and lower connectors are hook-shaped.

15. A method for assembling a vehicle door, the method comprising:
securing a door latching mechanism, a device for raising and lowering a window, and at least one accessory control to a first side of a door module, the first side being concealed from view after assembly and including a plurality of lower connectors and a plurality of upper connectors, the door module including a second side having interior trim exposed after assembly;
inserting the plurality of lower connectors into corresponding elongated slots of a door frame, the lower connectors supporting the door module on the door frame to provide access during assembly to the at least one accessory control and the device for raising and lowering a window;
pivoting the door module about the lower connectors to insert the plurality of upper connectors into corresponding elongated slots in the door frame; and
sliding the door module from an insertion position to a final assembly position such that at least the upper connectors engage the corresponding elongated slots of the door frame to secure the door module to the door frame.

16. The method of claim 15 further comprising securing the door module in the final assembly position.

17. The method of claim 16 wherein the door module is secured in the final assembly position by inserting threaded fasteners through the door frame into the door latching mechanism.

18. The method of claim 15 further comprising connecting the at least one accessory control to a wiring harness after inserting the plurality of lower connectors into the corresponding elongated slots of the door frame.

19. The method of claim 15 wherein the door module comprises a one-piece unitary construction.
